(19) United States
(12) Patent Application Publication
(10) Pub. No.: US 2018/0218387 A1
(43) Pub. Date: Aug. 2, 2018

(54) FEEDBACK SYSTEM THROUGH AN ONLINE COMMUNITY FORMAT

(71) Applicants: Price-Mars Delly, New York, NY (US); Laurent Delly, New York, NY (US)

(72) Inventors: Price-Mars Delly, New York, NY (US); Laurent Delly, New York, NY (US)

(21) Appl. No.: 15/419,462

(22) Filed: Jan. 30, 2017

(51) Int. Cl. G06Q 30/02; H04L 29/08; G06Q 10/06; G06Q 50/00

(52) U.S. Cl. CPC G06Q 30/0217; H04L 67/10; H04L 67/306; G06Q 10/06395; G06Q 50/01; G06Q 30/0239

(57) ABSTRACT

A feedback system is provided. The feedback system provides online feedback community marketplace connecting commercial feedback receivers, feedback submitters, and a matching algorithm. The matching algorithm identifies specific feedback submitters matching the specific skill-sets, interests, preferences and experiences being sought by the feedback receivers in regards to their commercial venture(s). The feedback system enables the feedback receivers to associate with the identified feedback submitters through a feedback project defined by the former. In response to personalized feedback data tailored to the feedback project a reward and incentive is provided to the respective feedback submitters. The feedback system exports the feedback data in the form of a feedback sticker that associated feedback receivers can display at their place of business.

### BACKGROUND OF THE INVENTION

The present invention relates to methods of improving commercial goods and services and, more particularly, to a feedback system for delivering sustainable feedback through an online community format in exchange for incentives.

Currently, there is not an online platform of a community feedback marketplace providing feedback that captures the whole social experience of the feedback submitter. Rather, current commercial feedback processes available today focus on open-ended surveys filled with general questions that sheds no light on the process of learning how customers interact with the products and services being delivered by entrepreneurs, businesses, and organizations. Such open-ended surveys do not capture the whole social experience of the feedback sender, they do not offer personalized feedback in an online community marketplace format as a means to improve a service or product, and they do not offer custom rewards and incentives that can encourages the submission of high-quality feedback in either in a virtual (online) or a live (in-person) setting.

As can be seen, there is a need for a system for delivering feedback through an online community format in exchange for incentives, through which customized rewards and incentives from entrepreneurs, businesses and organizations are provided in return for the delivery of personalized feedback given for the purpose of improving a product or service at any phase of the life-cycle. Whereby this process adds customization and personalization to the feedback receiving process for all businesses, and organizations, and allows all users to identify all the pieces of information that are vital for improvement of the goods and services being sold to the customer. In addition, it allows users to effectively pinpoint unique flaws and opportunities through a mutually beneficial (reward-based) process. As a result, the present invention utilizes skills, knowledge or personal experience metrics as the basis of delivering unique and tailored feedback designed to improve the business value proposition of the service or product being offered to a customer.

### SUMMARY OF THE INVENTION

In one aspect of the present invention, a feedback system for delivering feedback through an online community format in exchange for incentives includes providing an online community feedback network coupling a plurality of feedback receivers and a plurality of feedback submitters, wherein each feedback receiver provides a respective good or a respective service, and wherein each feedback submitter is defined by a demographic profile; prompting at least one feedback receiver of the plurality of feedback receivers to define a feedback project having: a project demographic profile; at least one question, wherein the at least one question pertains to the respective good or the respective service; and a reward; identifying at least one matching feedback submitter of the plurality of feedback submitters based in part by comparing the project demographic profile and the demographic profile associated with each matching feedback submitter; prompting the at least one matching feedback submitter to provide a feedback response to the at least one question; transmitting the feedback response to said at least one feedback receiver; and prompting said at least one feedback receiver to deliver the reward to the at least one matching feedback submitter.

In another aspect of the present invention, the feedback system includes providing an online community feedback network coupling a plurality of feedback receivers and a plurality of feedback submitters, wherein each feedback receiver provides a respective good or a respective service, and wherein each feedback submitter is defined by a demographic profile; prompting at least one feedback receiver of the plurality of feedback receivers to define a feedback project having: a project demographic profile, wherein the project demographic profile comprises at least one of a skill-set, an interest, a preference and an experience; at least one question, wherein the at least one question pertains to the respective good or the respective service; a quality control measure; background information of the respective good or the respective service; and a reward; identifying at least one matching feedback submitter of the plurality of feedback submitters based in part by comparing the project demographic profile and the demographic profile associated with each matching feedback submitter; prompting the at least one matching feedback submitter to provide a feedback response to the at least one question; transmitting the feedback response to said at least one feedback receiver; prompting said at least one feedback receiver to deliver the reward to the at least one matching feedback submitter; and exporting a predetermined portion of the feedback response to said at least one feedback receiver in the form of a feedback sticker, wherein the quality control measures defines the predetermined portion the feedback response.

These and other features, aspects and advantages of the present invention will become better understood with reference to the following drawings, description and claims.

### BRIEF DESCRIPTION OF THE DRAWINGS

FIG. 1 is a schematic view of a process overview of an exemplary embodiment of the present invention;

FIG. 2 is a schematic view of a selection tabs of an exemplary embodiment of the present invention;

FIG. 3A is a schematic view of a background input screen for a premium and a basic option of an exemplary embodiment of the present invention;

FIG. 3B is a schematic view of a background input screen for a premium and a pro option of an exemplary embodiment of the present invention;

FIG. 4A is a schematic view of a details input screen for the basic option of an exemplary embodiment of the present invention;

FIG. 4B is a schematic view of a details input screen for the premium option of an exemplary embodiment of the present invention;

FIG. 4C is a schematic view of a details input screen for the pro option of an exemplary embodiment of the present invention;

FIG. 5 is a schematic view of a ratings input screen for the premium and pro option of an exemplary embodiment of the present invention;

FIG. 6A is a schematic view of a simple multiple choice question input screen of an exemplary embodiment of the present invention;

FIG. 6B is a schematic view of a yes-no/detailed multiple choice input screen of an exemplary embodiment of the present invention;

FIG. 7 is a schematic view of a reward input screen of an exemplary embodiment of the present invention;

FIG. 8 is a schematic view of a feedback search menu of an exemplary embodiment of the present invention;

FIG. 9 is a schematic view of a searchable project template of an exemplary embodiment of the present invention; and

FIG. 10 is a schematic view of a feedback submitter match of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an online feedback community marketplace adapted for people, businesses, and organizations to find specific individuals that match specific skill-sets, interests, preferences and experiences that are being sought, invite those individuals to give feedback on personalized issues, for example challenges in a social format (video, audio, images and social media) and in return, give them a reward and incentive for their feedback. The process also allows businesses to obtain both solicited and unsolicited feedback on selected topics continuously and distribute a feedback sticker in their place of operation such as a store, and thereby enable businesses to learn not only where to improve but also how and what to improve quicker. This process offers an online community-based format that is flexible and enables for example, a start-up to beta test a new cleaning product prior to releasing it in the market, or alternatively, a 3-star restaurant to learn from their customer base quickly and allowing them to transform into a 4-star food service by just implementing the feedback obtained from their customers via the feedback sticker exported and printed from the online feedback project.

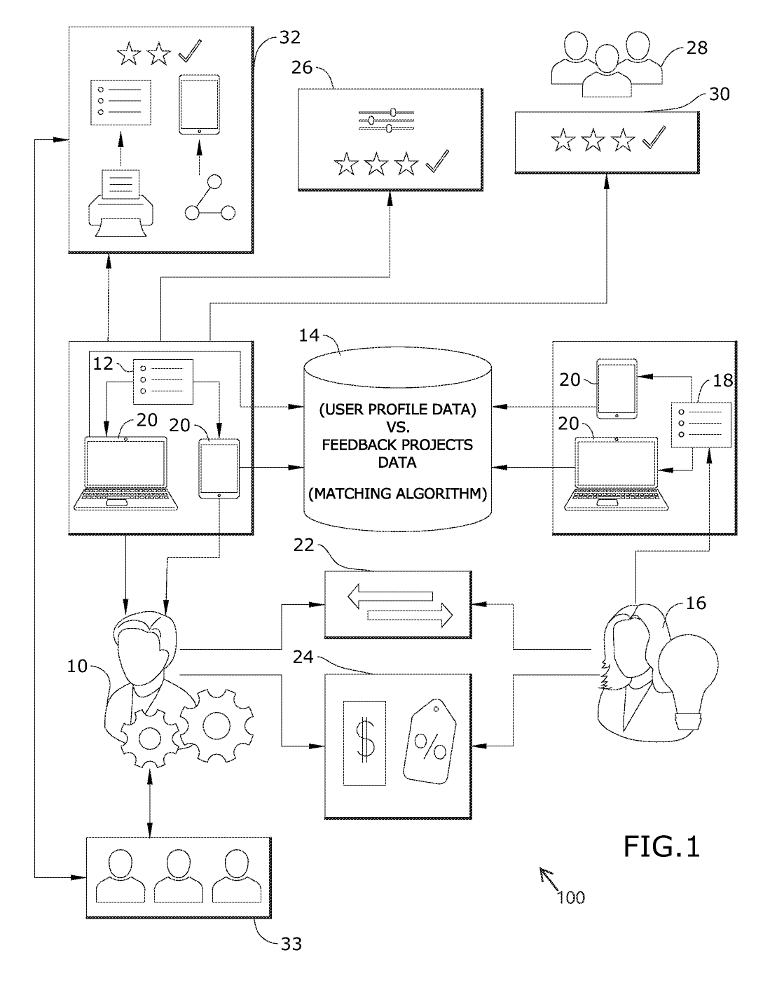

Referring to FIG. 1, the present invention may include at least one computer 20 with a user interface, wherein the user interface. The computer 20 may include at least one processing unit coupled to a form of memory. The computer 20 may include, but not limited to, non-user-interface computing devices, such as a server and a microprocessor, and user-interface computing devices, such as a desktop, a laptop, and smart device, such as a tablet, a smart phone, smart watch, or the like. The computer 20 may include a program product including a machine-readable program code for causing, when executed, the computer to perform steps. The program product may include software which may either be loaded onto the computer 20 or accessed by the computer 20. The loaded software may include an application on a smart device. The software may be accessed by the computer using a web browser. The computer 20 may access the software via the web browser using the internet, extranet, intranet, host server, internet cloud, wifi network, and the like.

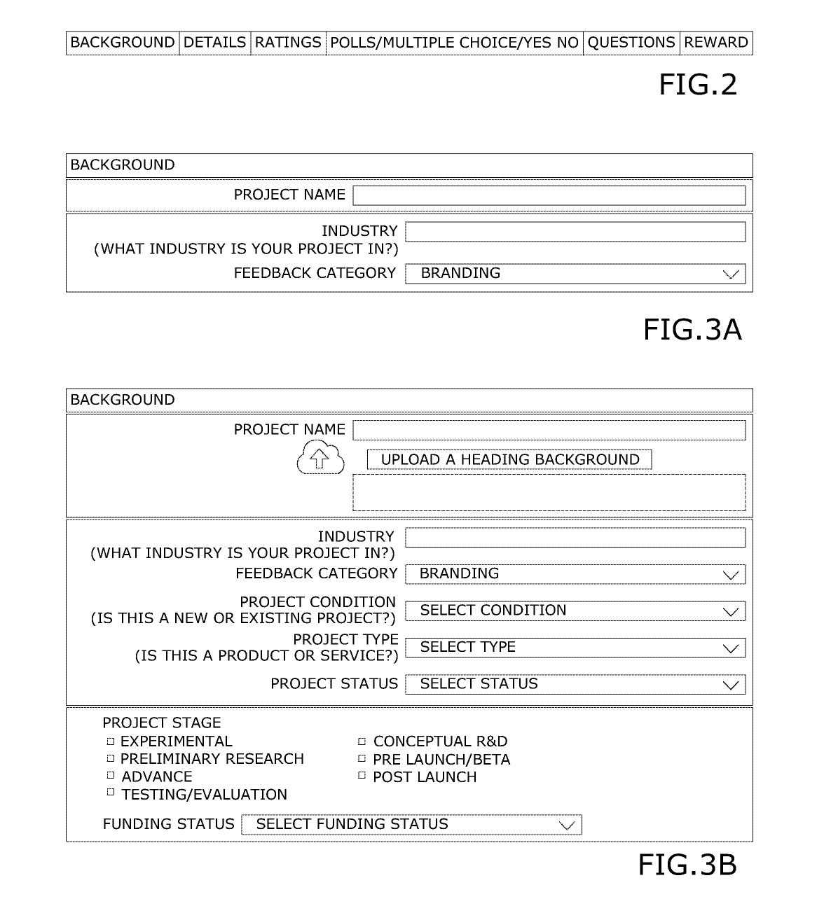

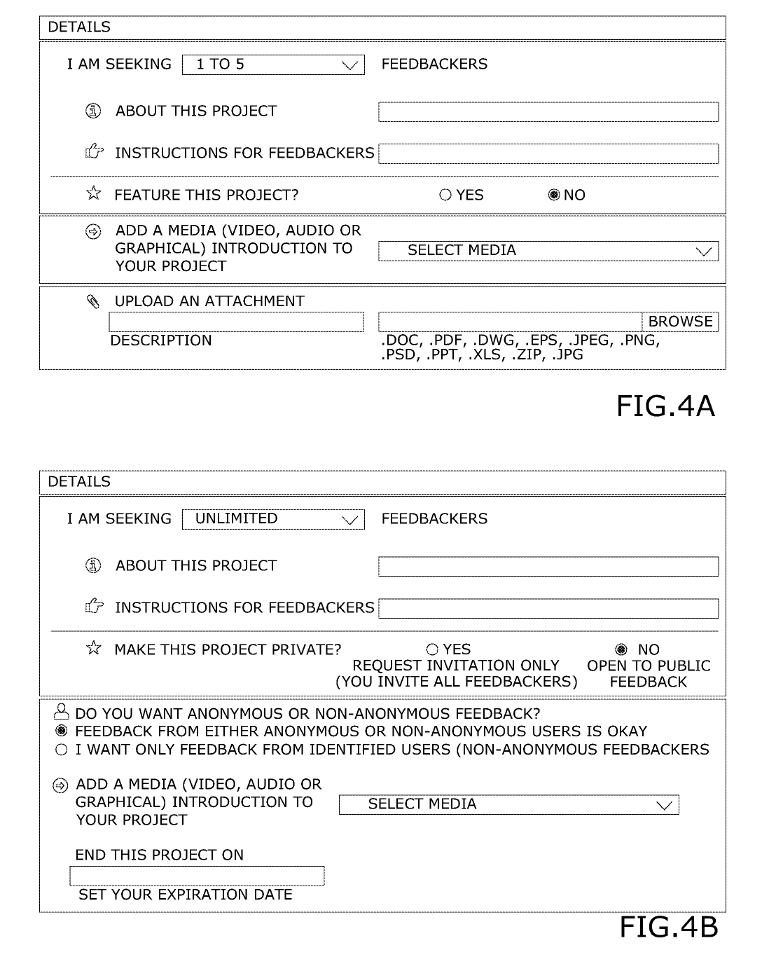

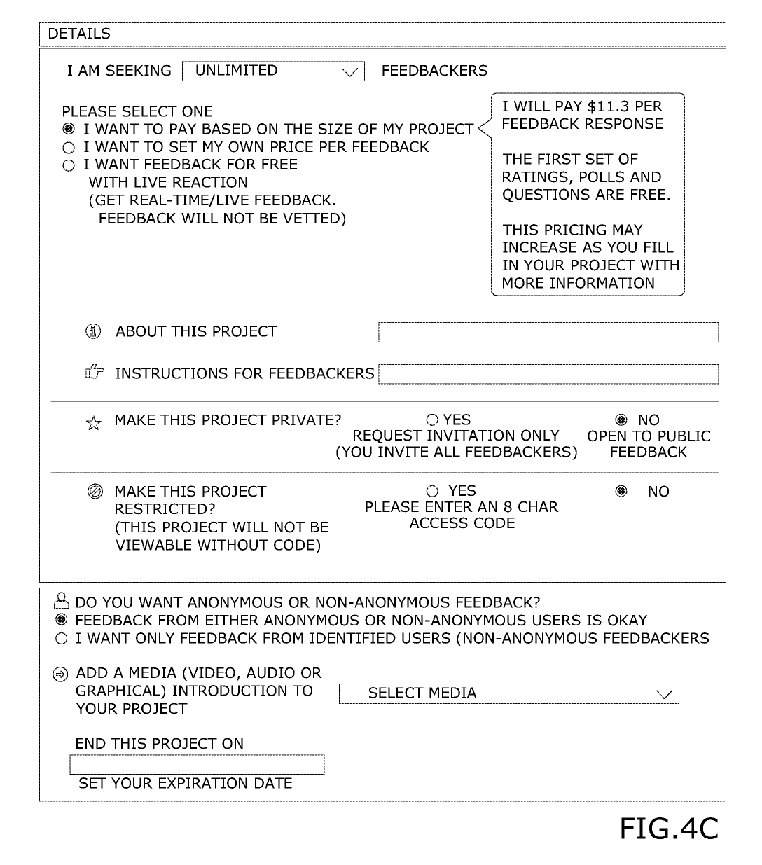

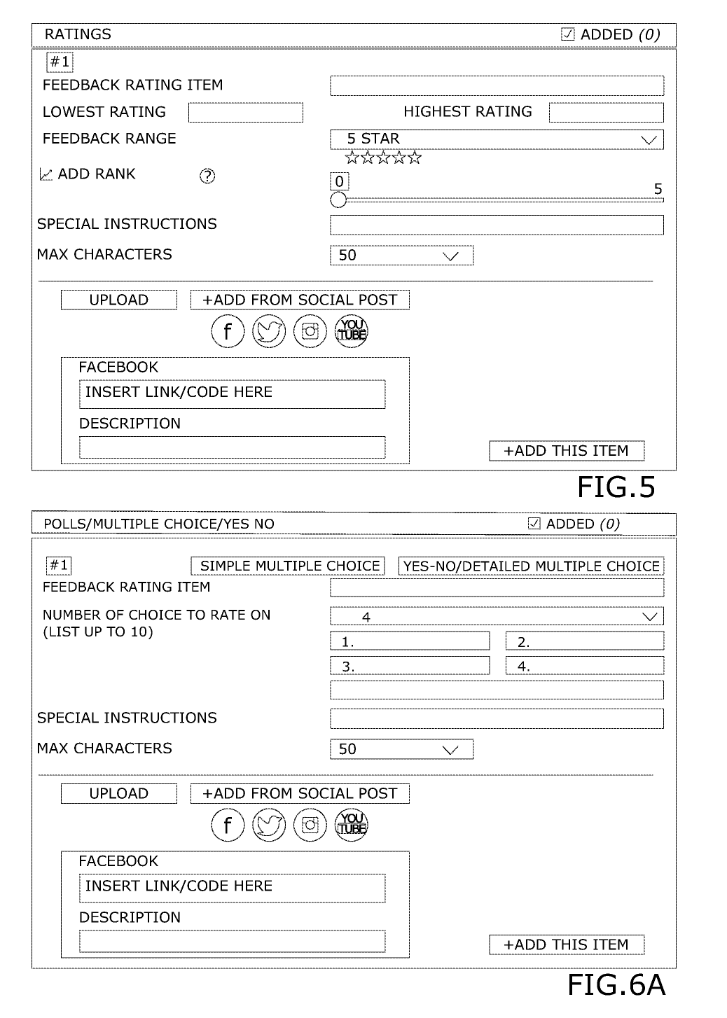

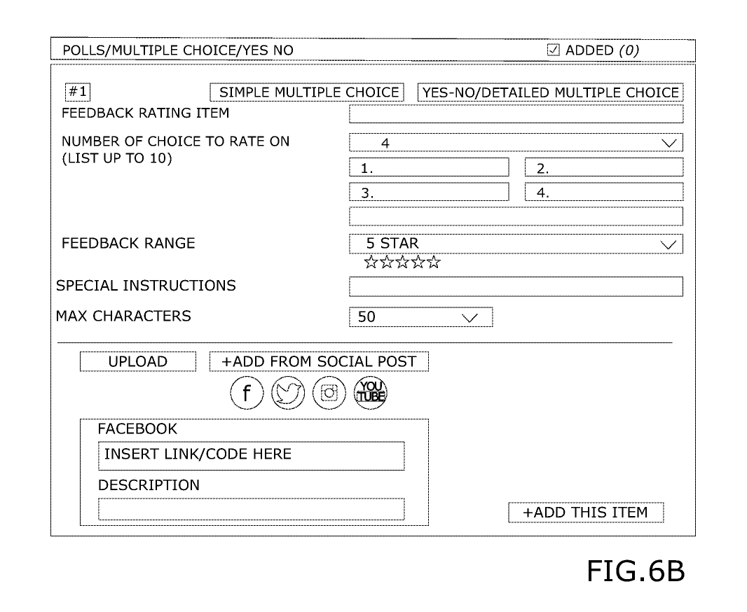

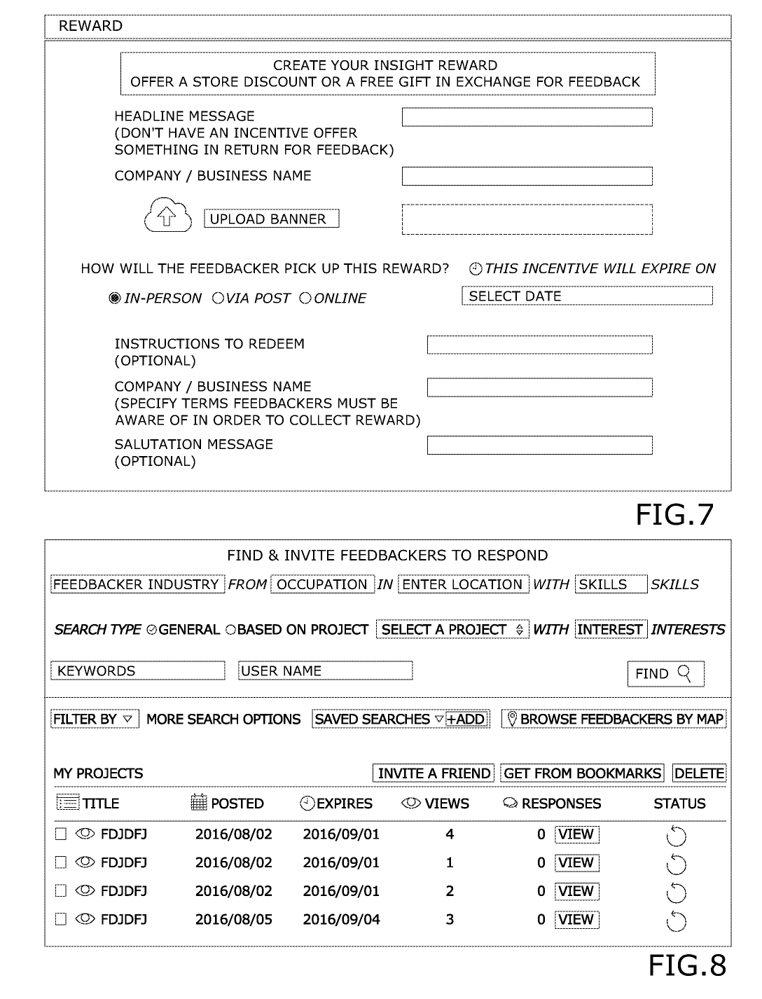

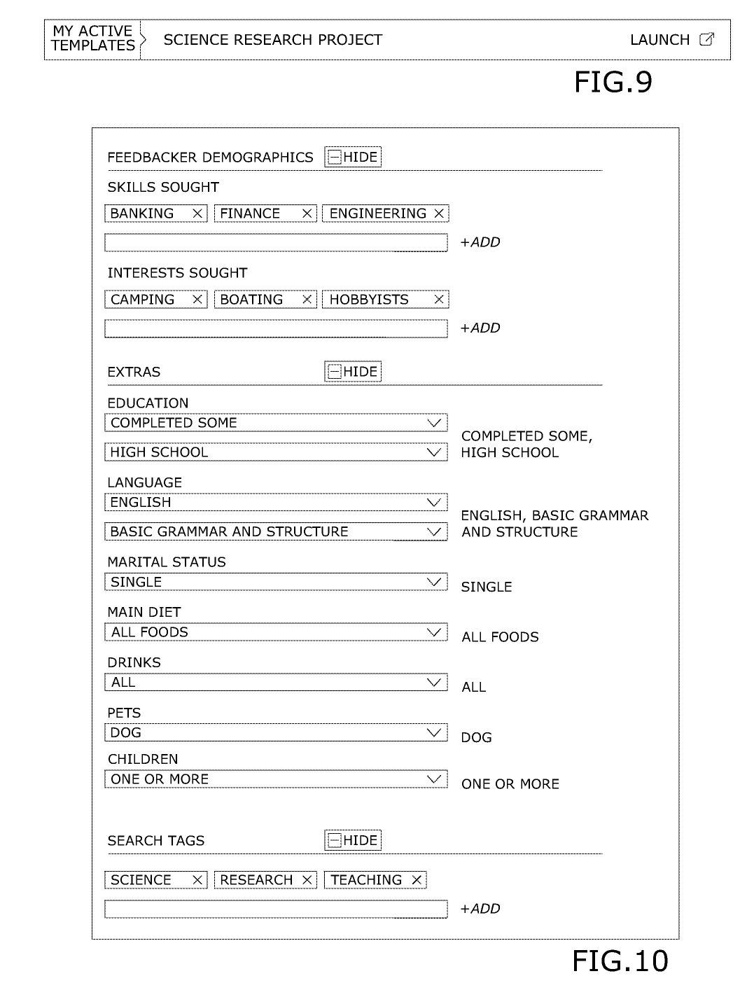

Referring to FIGS. 1 through 10, the present invention may include a feedback system 100 having a plurality of feedback receivers 10 and a plurality of feedback submitters 16 connected to an online feedback community network 14. The plurality of feedback receivers 10 may include sole proprietors, business entities, organizations, interest groups, and the like. The online feedback community network 14 may include an Internet-based platform providing an electronic data storage of information from the feedback receivers 10 and live feedback submitters 16, general user profile data, feedback project data, Internet data, and brand profile pages coupled to a matching algorithm. The matching algorithm may be adapted to use similarities in the above-mentioned data sets (including feedback response data 12) and machine intelligence learning.

The feedback submitter 16 may be a commercial user of a good or service of a feedback receiver 10. The feedback submitter 16, based in part on such use, submits, through the online feedback community network 14, feedback response data 12, which includes insight in the form of electronic data, written and completed polls, responses, live (real-time voting) data, messages, inquiries, and the like. Thereby the feedback response data 12 is associated and communicated to the feedback receiver 10 by the present invention, in certain embodiments, after being prompted in the form of a messaging inquiry, demand or release of access information, or the like.

The feedback response data 12 may be accessed by the feedback receiver 10 in the form of electronic representations of the written comments, graphical outputs, and the like made by the feedback submitter 16 and all other assessment-based information sent to the associated feedback receiver 10 through their project dashboard.

The incentives and rewards 24 may be released once the feedback response data 12 has been approved by the associated feedback receiver 10. The incentives and rewards 24 may include incentives and rewards given via online, shop, mail, or live (in person), electronically or physically. Such feedback response data 12 is exportable to other registered users of the platform as shared feedback 32. The shared feedback 32 may be printed or electronically shared feedback data; for example, polls, votes, or other data and information from feedback submitter.

Shared feedback 32 is subject to quality control measures 26. The quality control measures 26 may be adapted to define how, what portion, and to whom the feedback response data 12 is exported and shared. The feedback response data 12 may be shared with business entities 28 as well as other peers 33 affiliated with the associated feedback receiver 10. The business entities 28 may include organizations, brands, businesses, sole proprietors, competition organizers and the like affiliated with the associated feedback receiver 10. The business entities 28, if registered users of the platform, may also provide entity feedback to and through the platform of the present invention. The other peers 33 may be either offline peers or online, as defined by the quality control measures 26. The feedback response data 12 may be shared, electronically or in printed form, in excerpts from their feedback projects as a feedback sticker 30, a receipt or via an API (application programming Interface). The present may have the capability to digitally distribute projects in compact form to customers on products and services.

The analytics provided through a dashboard of the feedback receivers 10 reveals metrics on how to avoid pitfalls, and increase value and customer retention.

A method of using the present invention may include the following. The feedback system 100 disclosed above may be provided. A user may initially sign-up through a required process, wherein associated user profile information 18 needs to be entered in order to create a user record into the platform's database. In total, users have three (3) options to sign-up and each option offer various advantages in comparison to the other two.

The first sign-up option allows users to sign-up relatively quick, and is designed for users who are initially considering to use the platform in the capacity to be feedback receivers 10, feedback submitters 16, or both.

The second sign-up option allows users to specify their role in using the platform to either receive or submit feedback as an (entrepreneur, Business, Start-up, Non-Profit, Organization, Student or Other option). In addition, this option allows users to add more personal information such as their full name, and gives users the flexibility to select an alternate sign-up option altogether such as via 1 of 4 Social Media APIs embedded in the platform including, but not limited to Facebook™ Twitter™, Google PIus™, and Linkedin™.

The third (sign-up) option is designed for the feedback receiver 10, and allows users to create a simple profile, post a basic one-question (or more) feedback project, and search and find feedback submitters 16 instantly who are relevant to their project requirements.

For example, a restaurateur who is looking to understand how to build a better menu and increase sales can use this invention in the following manner:

The restaurant owner would start by signing up using one of three posting options and then creating a profile. The owner would then proceed to create a customized project based on the problems experienced with the existing menu.

Through each section of the project posting process, the restaurant owner would add various pieces of information such as background information of the restaurant, project stage, and funding status. Next, the owner would then describe the feedback project in more detail and provide instructions for feedback submitters 16 to evaluate and submit insight or feedback. The restaurateur would then select if he is seeking public or private feedback, and select from anonymous or non-anonymous feedback. The restaurateur would then add a media such as a video clip of the problem area (a customer flipping through the food menu), set an expiration date that specifies when to stop receiving feedback, and upload any additional file attachments for feedback submitters 16 to use or review during the feedback submission process.

The restaurateur would then proceed to add as many ratings, polls, and questions that target the problem areas faced with correcting the menu. A sample question might ask: How long does it typically takes you to place an order from our menu and offer options such as: less than one minute, 1 to 5 minutes, 5 to 10 minutes, or 10 to 20 minutes.

Next, the restaurateur would then be allowed to create a customized reward to post with the project. The restaurateur might decide to post a reward that offers feedback submitters either 20 percent off on coffee purchased or a free mug in exchange for feedback. The last steps of the project posting process enables the restaurateur to create a demographic profile that targets specific feedback submitters 16, add in experienced-based requirements for feedback submitters 16, and enter in a promotional code in order to be qualified for a posting discount. Once the project is posted, the restaurateur is then presented with the feedback submitter screen, which allows the searching for feedback submitters based on several options including: Industry, Occupation, Location, Skills, Interests, Project-based keywords, username, gender, age range, and proximity to business. Feedback submitters 16 can also be located and hand-pick picked by the restaurateur via a feedback submitter map.

Once a feedback submitter 16 is found, the feedback submitter 16 information card will display a match percentage. If a feedback submitter 16 meets the requirements set by the restaurateur and the project details, she is sent an invitation to respond and submit feedback. After the feedback submitter 16 views the email notification, she logs in and begins submitting feedback on the project.

During the project, the restaurateur will receive and view various feedback reports sent from invited and non-invited feedback submitters. The restaurateur has the option to prolong the menu improvement project past the expiration date, and will be able to print “feedback stickers” to notify customers of an online feedback project and the 20% off coffee reward (for example) tied to the project. The restaurateur at any stage of the feedback process will be able to use the live-feedback option as a tool to get live feedback, votes and insight during an event held at the restaurant. All feedback data received by the restaurateur will be analytical, textual, graphical, and numerical in form. The data will reveal where the problem areas are with the menu, and offer the restaurateur insight on recommendations on how to improve. The restaurateur 22 has the option to voluntarily submit feedback to customers, entrepreneurs or other businesses with posted feedback projects on the platform at any time.

Additionally, the present invention can be used by doctors who are looking to understand what their patients' needs are the most, and examine how to improve the daunting experience of visiting the doctor. Also, the present invention can be used by an inventor who is looking to learn how to develop a better self-cleaning product from a specific market segment of mobile phone users. This product can be used by college students who are looking to conduct research on a design project in an effort to understand how to build a better conceptual model in a senior-level design class. This product can be used in a team research setting where members can be located remotely and give feedback on a scientific problem. This invention can also be used in an event or competition based setting to poll an audience and get real-time feedback on a show or an event to better understand the mindset and decisions of attendees or guests.

Furthermore, the present invention can produce a feedback sticker that is directly printed from one's feedback project, which can be posted on products and services and distributed directly to customers to provide online feedback.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented method, comprising:
providing an online community feedback network coupling a plurality of feedback receivers and a plurality of feedback submitters, wherein each feedback receiver provides a respective good or a respective service, and wherein each feedback submitter is defined by a demographic profile;
prompting at least one feedback receiver of the plurality of feedback receivers to define a feedback project comprising:
a project demographic profile;
at least one question, wherein the at least one question pertains to the respective good or the respective service; and
a reward;
identifying at least one matching feedback submitter of the plurality of feedback submitters based in part by comparing the project demographic profile and the demographic profile associated with each matching feedback submitter;
prompting the at least one matching feedback submitter to provide a feedback response to the at least one question;
transmitting the feedback response to said at least one feedback receiver; and
prompting said at least one feedback receiver to deliver the reward to the at least one matching feedback submitter.

2. The method of claim 1, further comprising exporting a predetermined portion of the feedback response to said at least one feedback receiver in the form of a feedback sticker.

3. The method of claim 2, wherein the feedback project further comprises a quality control measure, wherein the quality control measures defines the predetermined portion the feedback response.

4. The method of claim 1, wherein the feedback project further comprises a background information of the respective good or the respective service.

5. The method of claim 1, wherein the at least one question comprises a challenge in an online social format.

6. The method of claim 1, wherein the project demographic profile comprises at least one of a skill-set, an interest, a preference and an experience.

7. A computer implemented method, comprising:
providing an online community feedback network coupling a plurality of feedback receivers and a plurality of feedback submitters, wherein each feedback receiver provides a respective good or a respective service, and wherein each feedback submitter is defined by a demographic profile;
prompting at least one feedback receiver of the plurality of feedback receivers to define a feedback project comprising:
a project demographic profile, wherein the project demographic profile comprises at least one of a skill-set, an interest, a preference and an experience;
at least one question, wherein the at least one question pertains to the respective good or the respective service;
a quality control measure;
background information of the respective good or the respective service; and
a reward;
identifying at least one matching feedback submitter of the plurality of feedback submitters based in part by comparing the project demographic profile and the demographic profile associated with each matching feedback submitter;
prompting the at least one matching feedback submitter to provide a feedback response to the at least one question;
transmitting the feedback response to said at least one feedback receiver;
prompting said at least one feedback receiver to deliver the reward to the at least one matching feedback submitter; and
exporting a predetermined portion of the feedback response to said at least one feedback receiver in the form of a feedback sticker, wherein the quality control measures defines the predetermined portion the feedback response.
